(19) United States
(12) Patent Application Publication
(10) Pub. No.: US 2011/0062794 A1
(43) Pub. Date: Mar. 17, 2011

(54) METHOD FOR SWITCHING A MULTIMEDIA SOURCE AND MULTIMEDIA SINK FROM AN OPERATING MODE TO A STANDBY MODE, AND FROM A STANDBY MODE TO AN OPERATING MODE

(75) Inventors: Theodorus Anna Peter Gertrudis Vergoossen, Eindhoven (NL); Gerardus Maria Van Loon, Eindhoven (NL); Syed Hassan Akbar, Singapore (SG); Dengzhai Xiong, Singapore (SG); Chun Hsing Wu, Singapore (SG); Kok Siang Tan, Singapore (SG)

(73) Assignee: Koninklijke Philips Electronics N.V., Eindhoven (NL)

(21) Appl. No.: 12/992,628

(22) PCT Filed: May 20, 2009
(86) PCT No.: PCT/IB09/52097

§ 371 Date: Nov. 15, 2010

(30) Foreign Application Priority Data
May 26, 2008 (EP) 08156893.3

(51) Int. Cl. H02B 99/00

(52) U.S. Cl. 307/125

(57) ABSTRACT

The invention relates to a method for switching a multimedia source and multimedia sink from an operating mode to a standby mode, and a method for switching a multimedia source and multimedia sink from a standby mode to an operating mode. When the consumer device comprises two distributed boxes, such as a TV in which the display (multimedia sink) is separated from the processing unit (multimedia source) via a cable, then meeting the green rules for standby power becomes more complicated. The power consumption of processing unit and display unit should be minimal in standby mode. The methods of the invention provide for synchronizing the power states of both units, such that only the relevant parts remain active. The method is applicable on configurations where a DisplayPort link is used between a multimedia source, such as a set-top box, and a multimedia sink, such as a display. The invention provides a reduction in overall power consumption, while still complying with the Display-Port configuration and operation standard. In an embodiment of the invention, the source and sink are configured to allow communication of standby and wake-up requests/commands when the transmitter and receiver for the auxiliary channel are powered down. The invention also provides embodiments where the switching to and from standby of the source is triggered by user

### FIELD OF THE INVENTION

The invention relates to a method for switching a multimedia source and multimedia sink from an operating mode to a standby mode, a method for switching a multimedia source and multimedia sink from a standby mode to an operating mode, a multimedia source and a multimedia sink.

### BACKGROUND OF THE INVENTION

Many multimedia systems are interfaced using DisplayPort, which specifies an open digital communications interface for use in both internal connections, such as interfaces within a PC or monitor, and external display connections. Such external connections may include those between any compatible digital audio/video source, such as a PC, set-top box, DVD player, A/V receiver and a compatible digital audio and/or video sink, such as a computer monitor or digital television (DTV), via a compatible link, such as a cable.

DisplayPort is an industry standard established by the Video Electronics Standards Association (VESA) to accommodate the growing broad adoption of digital display technology within the PC and CE industries. It consolidates internal and external connection methods to reduce device complexity, supports necessary features for key cross industry applications, and provides performance scalability to enable the next generation of displays featuring higher color depths, refresh rates, and display resolutions. Further details on this standard may be obtained from VESA (see the VESA web-site www.vesa.org).

FIG. 1 depicts an example of an interface between a multimedia source (100) and a multimedia sink (200) using DisplayPort. The interface comprises: the main link (310) which is a uni-directional, high-bandwidth and low-latency channel used to transport isochronous data streams such as uncompressed video and audio. Communication over this main link (310) is performed by a transmitter (110) comprised in the source (100) and a receiver (210) comprised in the sink (200); the auxiliary channel (320) is a halfduplex bidirectional channel used for link management and device (200) control. Communication over this auxiliary channel (320) is also performed by the transmitter (110) and receiver (210), with both the transmitter (110) and receiver (200) being arranged to receive and transmit.
the HPD (Hot Plug Detect) signal line, used to allow a sink (200) to issue an IRQ (interrupt request) to the source (100), and to also detect a hot-plug-event HPD pulse. The HPD line is also connected to the transmitter (110) and receiver (210);
the DisplayPort connector for external interfacing also comprises a power line (340). It is intended for powering either a DisplayPort repeater or a DisplayPort-to-Legacy converter.

The requirements for reducing the energy used by consumer devices is commonly met by providing a standby mode—if no activity is detected within a certain period of time, or if a specific command is given, the consumer device is switched into a standby or power saving mode, where only essential components remained powered. Typically, the consumer device is configured to detect a resumption of activity and/or a specific command, and to to switch the device components from standby mode back to the operating mode.

When the consumer device comprises two distributed boxes, such as a TV in which the display (multimedia sink) is separated from the processing unit (multimedia source) via one or more communication channels, then meeting the green rules for standby power becomes more complicated. Power consumption of processing unit and display unit should be minimal in standby mode, but typically standby modes are arranged in each component separately. Typically the multimedia source and sink are in different locations and connected via a cable, for example the source may be video recorder hidden from view, and the sink may be a display in plain view of the user. The user may, therefore, cannot always determine the mode of operation of the source.

### SUMMARY OF THE INVENTION

It is an object of the invention to provide a method for switching a multimedia source and multimedia sink to a standby mode, and a method for switching a multimedia source and multimedia sink from standby mode.

According to a first aspect of the invention the object is achieved with a method for switching a multimedia source and multimedia sink from an operating mode to a standby mode, the multimedia source having a transmitter and a source standby controller interfaced to the transmitter; the multimedia sink having a wake-up request generator, a receiver and a sink standby controller interfaced to the receiver and the wake-up request generator; the transmitter and receiver being interfaced via a first channel for bi-directional communication in the operating mode; the source standby controller and the wake-up request generator being interfaced via a second channel for detection of a wake-up request by the source standby controller in the standby mode; the method comprising:

in response to detecting a request to enter standby mode, the source standby controller:
generating a standby command on the first channel;
disabling the source side of the bi-directional communication by switching the transmitter to the standby mode, and
enabling monitoring for the wake-up request by the source standby controller via the second channel;

in response to detecting the standby command, the sink standby controller:
disabling the sink side of the bi-directional communication by switching (the receiver to the standby mode, and
enabling the generation of the wake-up request by the wake-up request generator via the second channel.

The source uses the standby controller to control the switching to standby mode so that power is saved in both the source and the sink simultaneously, i.e. the standby periods for the source and the sink are synchronized to a high degree. The source standby controller directly switches components of the source, in particular the transmitter, into standby mode, and generates a standby command to instruct the sink to enter standby mode. Upon receiving the instruction, the sink standby controller switches components of the sink, in particular the receiver, into standby mode.

Additionally, power consumption may be reduced even further because the method of the invention allows the transmitter and receiver modules to be switched to standby mode whilst retaining the flexibility of allowing the system to be switched from standby mode by the sink. The transmitter and receiver modules are used during normal operation for bi-directional communication via the first channel. Requests, such as commands from a remote control, pass between the source and sink over this first channel. In known systems, the transmitter and receiver must be permanently powered, even during standby modes, to enable wake-up initiated by the sink because the sinks in the known systems use the first channel to inform the source of any requests received.

The first channel may first be used to transmit the standby command to the sink. After that, setting the transmitter and receiver into standby mode has the effect of disabling the bi-directional communication via the first channel.

The sink, comprising a wake-up request generator, provides the most convenient way to wake the system because it is generally visible to the user, and therefore the user can quickly determine the mode of the sink, and if required take action. For example, the wake-up request generator may be configured to detect remote control activity or to detect the activation of a power switch to on as an indication that the user wishes to switch the source and sink from the standby mode. The wake-up request generator may therefore be arranged to generate a wake-up request upon detection of an appropriate indication.

The wake-up request generator is connected to the sink end of the second channel, and the source end of the second channel is connected to the source standby controller. When switched to standby mode, the source standby controller monitors the second channel for a wake-up request.

As the method of the invention synchronizes the switch to standby mode of the sink and source, the user may be sure that the source is also in standby mode when the sink is in standby mode. As only the source standby controller, the sink standby controller and the wake-up request generator need to be powered in the standby mode, the total power usage of the source and sink are reduced.

This method may be implemented between a multimedia source and a multimedia sink while still complying with the DisplayPort standard—the standard interface functions in the operating mode and the standard cable connections between sink and source are unchanged.

According to an embodiment of the invention, a method for switching to standby mode is provided where the transmitter and receiver are interfaced via the second channel for hot plug detection of the sink by the source (100) in the operating mode, and the method further comprises in response to detecting a request to enter standby mode, the source standby controller disabling the hot plug detection by switching the transmitter to the standby mode.

Hot plug detection forms part of the DisplayPort standard, and the connections normally provided for that purpose may also be utilized for the second channel of the invention without affecting the DisplayPorts functions in the operating mode.

According to an embodiment of the invention, a method is provided for switching to standby mode wherein the source standby controller and sink standby controller are directly interfaced via the first channel for the communication of the standby command from the source to the sink.

A direct interface means that the standby controllers are connected to the first channel directly—the interfacing does not go via the transmitter or receiver. This provides more flexibility in the switching to standby mode as the first channel may be used without the transmitter and receiver being in the operating mode. Therefore, the transmitter may be shut down immediately before or together with the generation of the standby command on the first channel.

According to an embodiment of the invention, a method is provided for switching to standby mode wherein the first channel comprises a first and second line, configured as an ac-coupled differential pair, the source standby controller is configured to generate the standby command by varying the dc-level of the first line, and the sink standby controller is configured to detect the variation in the dc-level of the first line as the standby command.

When the source and sink standby controllers are directly interfaced, generating and detecting the command using the dc-level means that no change is required in the DisplayPort standard—the use of ac-coupled differential lines during normal operation for the bi-directional communication is not affected by the additional configuration of the source and sink.

In a further embodiment of the invention, a method for switching to standby mode is provided wherein the second channel is configured to convey a low logical state in standby mode when no wake-up request is generated by the wake-up request generator, and the wake-up request generator is configured to generate the wake-up request in the standby mode by asserting a high logical state via the second channel.

This has the advantage that the configuration of the source and sink do not affect the operation of the source and sink in the operating mode, allowing compliance with the DisplayPort standard.

According to another embodiment of the invention, a method is provided for switching to a standby mode wherein the interfacing between the multimedia sink and the multimedia source further comprises a power line; the multimedia source further comprises a power supply configured to supply power in the standby mode to the source standby controller and to further supply power via the power line, and the multimedia sink is configured to supply power in the standby mode from the power line to the wake-up request generator and to the sink standby controller.

This allows the source to control the power used by the source and sink when in standby mode by providing the power itself.

According to still another embodiment of the invention, a method is provided for switching to a standby mode wherein the multimedia sink comprises a power switch, and the multimedia sink is configured to generate the request to enter standby mode when the power switch is activated to off.

This provides a high degree of flexibility for the end user because the source may be switched to standby mode by the user turning off the power to the sink. This is particularly useful when the source is hidden from view or difficult to reach.

According to a further embodiment of the invention, a method is provided for switching to a standby mode wherein the wake-up request generator of the sink further comprises a user activity detector, and the enabling of the generation of the wake-up request comprises coupling the output of the user activity detector to the second channel.

Typically, the sink device is located at a position convenient to detect user activity, such as by detecting remote control signals, or by detecting the user activate the on/off switch to on. This is not always the case for the source as it may be hidden within a cupboard. By providing wake-up signal generation via the sink, the user-friendliness of the system is increased.

According to a second aspect of the invention, a method is provided for switching a multimedia source and multimedia sink from a standby mode to an operating mode, the multimedia source having a transmitter and a source standby controller interfaced to the transmitter; the multimedia sink having a wake-up request generator, a receiver and a sink standby controller interfaced to the receiver and the wake-up request generator; the transmitter and receiver being interfaced via a first channel for bi-directional communication in the operating mode; the source standby controller and the wake-up request generator being interfaced via a second channel for detection of a wake-up request by the source standby controller in the standby mode; the method comprising:

in response to detecting a wake-up request, the source standby controller:
enabling the source side of the bi-directional communication by switching the transmitter to the operating mode, and
disabling the detection of the wake-up request by the source standby controller via the second channel;

in response to detecting the wake-up request, the sink standby controller:
enabling the sink side of the bi-directional communication by switching the receiver to the operating mode, and
disabling the generation of the wake-up request by the wake-up request generator.

When a wake-up request is generated by the wake-up generator of the sink, the standby controller detects this and switches the transmitter from standby mode to restore the source side of the normal operating functionality. The sink standby controller also detects the wake-up request generated by the sink, and switches the receiver from standby mode to restore the sink side of the normal operating functionality. The functionality required in standby mode, namely the generation and detection of the wake-up request via the second channel is disabled.

The sink controls the switching from standby mode so that the operating mode is restored in both the source and the sink simultaneously. The sink provides the most convenient way to wake the system because it is generally visible to the user, and therefore the user can quickly determine the mode of the sink, and if required take action. As the method of the invention synchronizes the switch from standby mode of the sink and source, the user may be sure that the source is also in the operating mode when the sink is in the operating mode.

A saving in power consumption is achieved because the method of the invention allows the transmitter and receiver modules to be in the standby mode whilst retaining the flexibility of allowing the system to be switched from standby mode by the wake-up request generator of the sink.

This method may be implemented between a multimedia source and a multimedia sink while still complying with the DisplayPort standard—the standard interface functions in the operating mode and the standard cable connections between sink and source may remain unchanged by the implementation of the invention.

According to an embodiment of the invention, a method is provided for switching from a standby mode, wherein the transmitter and receiver are interfaced via the second channel for hot plug detection of the sink by the source in the operating mode, and the method further comprises in response to detecting a wake-up request, the source standby controller enabling the hot plug detection by switching the receiver to the operating mode.

Hot plug detection forms part of the DisplayPort standard, and the connections normally provided for that purpose may also be utilized for the second channel of the invention without affecting the DisplayPorts functions in the operating mode.

According to an embodiment of the invention, a method is provided for switching from a standby mode, wherein the source standby controller and sink standby controller are directly interfaced via the first channel for the communication of a wake-up command from the source to the sink; the sink standby controller acts in response to detecting the wake-up command instead of the wake-up request, and the method further comprises in response to detecting the wake-up request, the source standby controller generating a wake-up command on the first channel.

A direct interface means that the standby controllers are connected to the first channel directly—the interfacing does not go via the transmitter or receiver. This provides more flexibility in the switching to standby sequence as the first channel may be used while the transmitter and receiver are still in standby mode. Therefore, the switching from standby mode is controlled by the source standby controller which instructs the sink standby controller by generating a wake-up command via the first channel. In this embodiment, the wake-up request may be detected at the source or at the sink.

According to an embodiment of the invention, a method is provided for switching from standby mode wherein the first channel comprises a first and second line, configured as an ac-coupled differential pair; the source standby controller is configured to generate the wake-up command by varying the dc-level of the first line, and the sink standby controller is configured to detect the variation in the dc-level of the first line as the wake-up command.

When the source and sink standby controllers are directly interfaced, generating and detecting the command using the dc-level means that no change is required in the DisplayPort standard—the use of ac-coupled differential lines during normal operation for the bi-directional communication is not affected by the additional configuration of the source and sink.

According to yet another aspect of the invention, a method is provided for switching from a standby mode, wherein the multimedia sink further comprises a power switch, and the wake-up request generator is configured to generate the wake-up request when the power switch is activated to on.

This provides convenience for the user because the power switch of the sink is usually easily accessible.

According to a further embodiment of the invention, a method is provided for switching from a standby mode wherein the wake-up request generator further comprises a user activity detector and the disabling of the generation of the wake-up request comprises uncoupling the output of the user activity detector to the second channel.

Typically, the sink device is located at a position convenient to detect user activity, such as by detecting remote control signals, or by detecting the user activate the on/off switch to on. This is not always the case for the source as it may be hidden within a cupboard. By providing wake-up signal generation via the sink, the user-friendliness of the system is increased.

According to a further embodiment of the invention, a method is provided for switching from a standby mode wherein the user activity detector comprises a remote-control detector and a power switch activation detector, and the method further comprises:

configuring the wake-up request generator to generate a first wake-up request when the multimedia sink detects activation of a remote-control detector;

configuring the wake-up request generator to generate a second wake-up request when the multimedia sink detects activation of a power switch, and

configuring the standby controller to distinguish between the first and second wake-up requests.

Being able to distinguish between the type of activity allows the wake-up sequences to be varied. For example, if activation of the power switch is detected, the source standby controller may instruct the main controller to transmit additional data to the sink in case the information was lost due to the power being off.

According to a still further aspect of the invention, a multimedia source is provided comprising: a transmitter and a source standby controller interfaced to the transmitter; the transmitter having an interface to a first channel for bi-directional communication with a multimedia sink in the operating mode; the source standby controller having an interface to a second channel for the detection of a wake-up request by the multimedia sink in the standby mode; the source standby controller being configured:
to detect in the operating mode a request to enter standby mode,
to generate in the operating mode a standby command on the first channel;
to disable the source side of the bi-directional communication by switching the transmitter to the standby mode, and
to enable in standby mode monitoring for the wake-up request via the second channel.

According to yet another aspect of the invention, a multimedia sink is provided comprising: a wake-up request generator, a receiver and a sink standby controller interfaced to the receiver and the wake-up request generator; the receiver having an interface to a first channel for bi-directional communication with a multimedia source in the operating mode; the wake-up request generator having an interface to a second channel for transmitting a wake-up request to the multimedia source in the standby mode; the sink standby controller being configured:
to detect in the operating mode a standby command via the first channel;
to disable in the operating mode the sink side of the bi-directional communication by switching the receiver to the standby mode, and
to enable in standby mode the generation of the wake-up request by the wake-up request generator via the second channel.

### BRIEF DESCRIPTION OF THE DRAWINGS

These and other aspects of the invention are apparent from and will be elucidated with reference to the embodiments described hereinafter.

In the drawings:

FIG. 1 shows an example of interfacing between a multimedia source and multimedia sink using the DisplayPort standard,

FIG. 2 depicts an example of interfacing between a multimedia source and multimedia sink using the DisplayPort standard according to the invention,

FIG. 3 shows a second embodiment of a multimedia source and a multimedia sink, configured to operate according to the DisplayPort standard and the methods of the invention,

FIG. 4 depicts more details of the multimedia source depicted in FIG. 3,

FIG. 5 depicts more details of the multimedia sink depicted in FIG. 3,

FIG. 6 depicts a further embodiment of a multimedia source and a multimedia sink, configured to operate according to the DisplayPort standard and the methods of the invention,

FIG. 7 depicts the method for switching from the standby according to the invention, and

FIG. 8 shows the method for switching to the standby according to the invention.

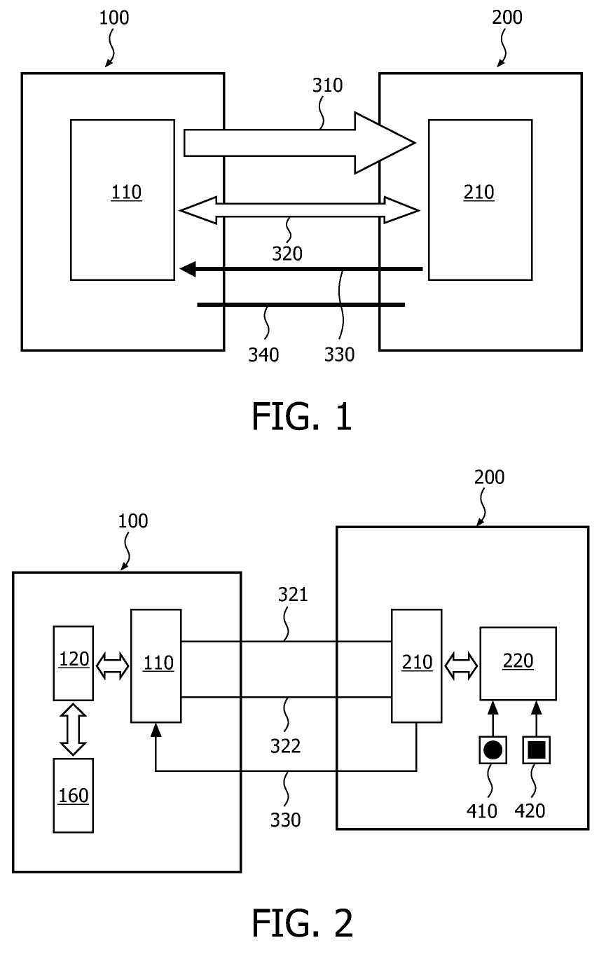

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE PREFERRED EMBODIMENTS

FIG. 2 depicts an example of interfacing between a multimedia source and multimedia sink using the DisplayPort standard according to a first embodiment of the invention, which allows synchronization of the standby modes of a source and a sink. Note that the main link connections to the transmitter (110) and receiver (210) are not depicted.

A multimedia source (100) comprises a transmitter (110), a main controller (120) and a standby controller (160). The transmitter (110) is connected to a first channel, the auxiliary channel (321, 322), for link management and sink device (200) control—the auxiliary channel comprises one differential pair (321, 322) transporting self-clocked data. The transmitter (110) is also connected to a second channel, the HPD line (330), for receiving interrupt requests (IRQ) generated by the sink device. The main controller (120) is linked by data pathways to the transmitter (110) for receiving IRQ requests, and also for supplying the transmitter (110) for the information to the transmitted to the sink (200) over the auxiliary channel (321, 322). The standby controller (160) is connected by data pathways to the main controller (120) such that the standby mode of the main controller (120) and the transmitter (110) may be controlled.

The sink (200) comprises a receiver (210), a display controller (220), a power switch (420) and an IR (infra-red) remote control signal detector (410). The receiver (210) is connected to the auxiliary channel (321, 322). Note that although there is a distinction made between a transmitter (110) and a receiver (210), both these modules may transmit and receive—the naming is chosen for this auxiliary communication channel because the source (100) is the master that initiates an auxiliary transaction, and the sink (200) is the slave that replies to the transaction initiated by the source (100). The receiver (210) is also connected to the HPD line (330) to generate interrupt requests (IRQ) to the source (100). The display controller (220) is linked by data pathways to the receiver (210) for receiving IRQ requests, for receiving requests for transactions from the source (100), and also for supplying the receiver (110) with the information to the transmitted back to the source (100) over the auxiliary channel (321, 322) in response to those requests. The display controller (220) is connected to the output of a power switch (420) and an IR (infra-red) remote control signal detector (410). The display controller (220) is configured to perform actions to switch the sink (200) from an operating mode to a standby mode, and from a standby mode to an operating mode.

During operation, all components of the source (100) and sink (200) are powered up normally, and the power switch (420) is set to on. User interaction in the form of remote control codes are received by the IR detector (410) by the display controller (220), passed to the receiver (210) and transmitted over the auxiliary channel (321, 322). These codes are received by the transmitter (110) and passed to the main controller (120) for processing. Additionally, source (100) commands may be passed to the transmitter (110), and transmitted over the auxiliary channel (321, 322). These source (100) commands are received by the receiver (210) in the sink device (200) and passed to the display controller (220) for further processing.

To enter standby mode, a specific command may be given. Specific commands may be an appropriate “STANDBY” of “OFF” code from the remote control detected by the IR detector (410) or the user setting the power switch (420) to off. In both these cases, the display controller (220) detects the appropriate output of the user activity detector (410, 420) and transmits the information to the source (100) over the auxiliary channel (321, 322). Alternatively, the sink (200) may detect that a predetermined period of inactivity has expired, and transmits the information to the source (100) over the auxiliary channel (321, 322). The source (100) receives this request to enter a standby mode, and the main controller (120) may then decide to switch the source and sink into standby mode. It does this by issuing a command to the standby controller (160) to take appropriate action (not depicted) to switch components of the source (100) into power saving mode, and to broadcast to the sink (200) over the auxiliary channel (321, 322). The display controller (220) may then take appropriate action to switch components of the sink (200), such as a display, into a power saving mode.

Alternatively, the display controller (220) may be configured to immediately take appropriate action to switch components of the sink (200) into a power saving mode when inactivity has been determined, and to then transmit the information over the auxiliary channel (321, 322) to the source (100). In this case, when the standby controller generates a standby command, the main controller (120) no longer needs to transmit the signal to the sink over the auxiliary channel (321, 322).

Note that the source (100) may be configured in a similar way to the sink (200) to detect that a certain period of inactivity has been exceeded, to detect a specific command, or to detect the activation of an OFF power switch, so that the request to enter standby mode may be also generated by the source (100).

The source (100) and sink (200) of FIG. 2 are configured to switch from standby mode when activity is resumed. This could be, for example, turning on the power switch (420), detecting an appropriate “ON” signal from the remote control using the IR detector (410) or detecting any remote control signal using the IR detector (410).

In the case of turning on the power switch (420), the display controller (220) will detect this and generate a wake-up request in the form of a Hot Plugging event of the sink device (200) over the HPD line (330) using the receiver (210). The standby controller (160) on the source receives this via the main controller (120) and then may decide to generate a wake-up command to instruct the main controller (120) to take appropriate action (not depicted) to switch components of the source (100) out of power saving mode, and to broadcast the wake-up command to the sink (200) over the auxiliary channel (321, 322). The display controller (220) may then take appropriate action to switch components of the sink (200), such as a display, out of the power saving mode.

Alternatively, the display controller (220) may be configured to immediately take appropriate action to switch components of the sink (200) out of power saving mode when activity has been determined, and to then transmit the information over the auxiliary channel (321, 322) to the source (100). In this case, when the standby controller generates a wake-up command, the main controller (120) no longer needs to transmit the signal to the sink over the auxiliary channel (321, 322).

In the case of the detection of a “ON” code from the remote control, the display controller (220) detects the appropriate output of the IR detector (410) and transmits the information to the source (100) over the auxiliary channel (321, 322) using the receiver (210). The standby controller (160) is informed by the main controller (120) of the wake-up request and then may decide to issue a wake-up command.

Note that the source (100) may also be configured to detect a resumption of activity or to detect a specific command so that a request to leave standby mode, or wake-up request, may also be generated by the source (100).

This first embodiment of the invention synchronizes the standby modes of the source (100) and sink (200) to a high degree, so that the degree of saving in power consumption may be optimized by ensuring that both the source (100) and sink (200) are both in standby mode as long as possible. Although a saving in overall power use is realized, it is not possible for the transmitter (110) and receiver (210) to be switched to a standby mode—they are needed to detect a possible wake-up request from the sink (200) and to transmit a wake-up command from the source (100) to the sink (200).

More power may be saved by configuring the transmitter (110) and receiver (210) so that functionality not required during standby mode, such as communication over the main link (not depicted), is disabled. The DisplayPort standard does permit the receiver (210) to be partially put into a “power saving” state by the sink device—in this mode of operation, the receiver (210) may only detect the presence of a differential signal input without replying to a request transaction over the auxiliary channel. Upon detecting the presence of a differential signal input, the sink (200) may decide to exit the “power saving” state. However, this still requires the transmitter (110) to be fully powered, and it is not possible to enable the wake-up request for both the source (100) and the sink (200) to be generated by the sink (200).

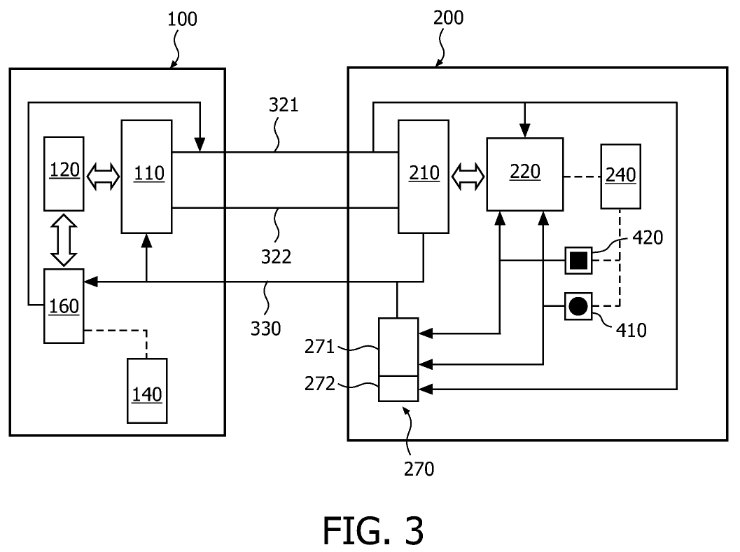

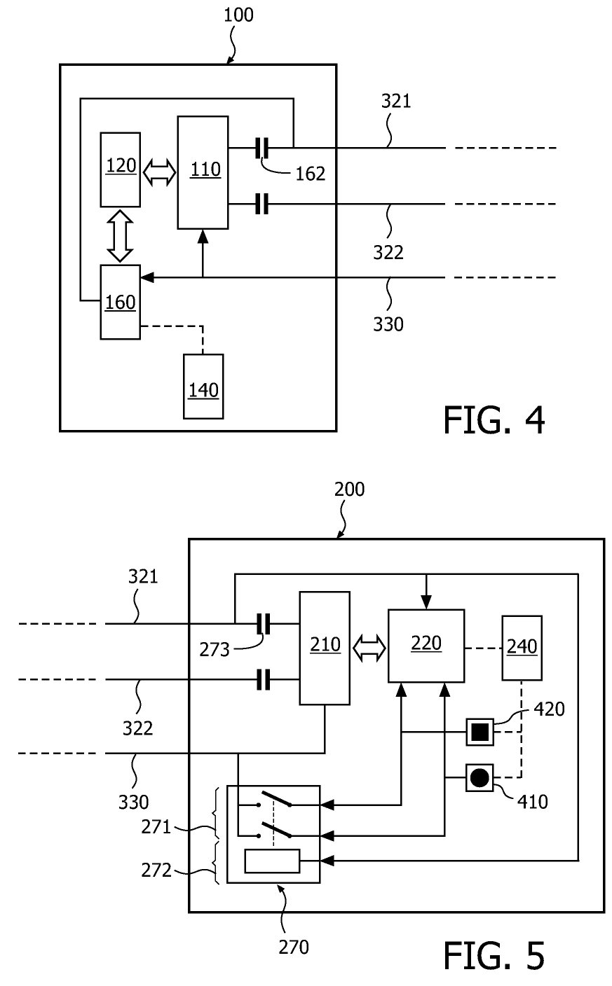

FIG. 3 depicts a second embodiment of a multimedia source (100) and a multimedia sink (200), configured to operate according to the DisplayPort standard and the methods of the invention. FIG. 4 depicts more details of the multimedia source depicted in FIG. 3, and FIG. 5 depicts more details of the multimedia sink depicted in FIG. 3. The embodiment of FIG. 3 is the same as the embodiment of FIG. 2, except for the differences described below.

The standby controller (160) is connected to the HPD line (330) to receive HPD signals and interrupts, and it is also connected to one of the lines (321) of the auxiliary channel (321, 322). It will be apparent to the skilled person that the standby controller (160) may be connected to either of the differential pair (321, 322). The connection to the auxiliary line (321) is configured such that the standby controller (160) may vary the dc-level of the auxiliary line (321). This cannot be performed by the transmitter (110) because according to the DisplayPort standard, the lines of the auxiliary channel (321, 322) are ac-coupled. One way to do this is to attach the connection to the auxiliary line (321) at a point between the ac-coupling, for example a capacitor (162), and the external connection of the source (100) to the interface line (321).

The sink (200) further comprises an output selector (270), comprising a switching part (271) and a selector controller (272) for the switching part (271). The switching part is connected to both the HPD line (330) and the outputs of the user activity detectors (420, 410), such that when activated, the outputs of the user activity detectors (420, 421) are connected to the HPD line (330). The selector controller (272) is connected to the same auxiliary line (321) as the standby controller (160), and the connection is configured such that the selector controller (272) may detect the dc-level of the auxiliary line (321). One way to do this is to attach the connection to the auxiliary line (321) at a point between the ac-coupling, for example a capacitor (273), and the external connection of the sink (200) to the interface line (321).

Additionally the display controller (220) is connected to the same auxiliary line (321) as the standby controller (160), and the connection is configured such that the display controller (220) may detect the dc-level of the auxiliary line (321).

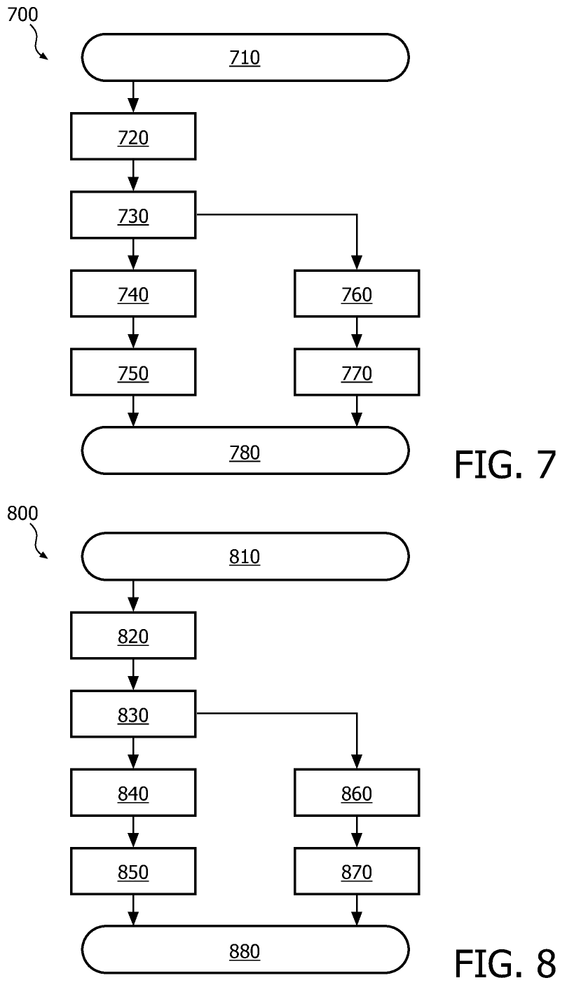

The operation of the embodiment of FIGS. 3, 4 and 5 is depicted in FIG. 7 and FIG. 8.

FIG. 8 shows the method (800) for switching to the standby mode according to the invention. Both the source (100) and the sink (200) are initially in the operating mode (810), i.e. not in standby mode. During this the operating mode (810), all components of the source (100) and sink (200) are powered up normally, and the power switch (420) is set to on.

The standby controller (160) detects (820) a request to enter standby mode, which may come from the source (100) or the sink (200). In response to this request, the standby controller (160) switches (840) the transmitter (110) to standby mode, and generates (830) a standby command on the auxiliary line (321) to which it is connected. Due to the additional connection to the auxiliary line (321), the standby controller (160) does not need the transmitter (110) to be powered to send the command over the auxiliary line (321), so switching (840) the transmitter to standby mode and generating (830) the standby command may be performed in any order or simultaneously. The standby mode for the transmitter (110) according to the invention means that the transmitter (110) is no longer able to communicate with the sink (200) over the auxiliary channel (321, 322) in a mode comparable to the operating mode. This means that in standby mode a complete powering down of the transmitter (110) is possible, or a partial powering down if it is desired to retain other functionality during the standby mode.

The standby controller (160) then enables (850) the monitoring of the HPD line (330) for any future wake-up request from the sink (200).

The display controller (220) detects the standby command, and in response, switches (860) the receiver (210) to standby mode. The standby mode for the receiver (210) according to the invention means that the receiver (110) is no longer able to communicate with the source (100) over the auxiliary channel (321, 322) in a mode comparable to the operating mode. This means that in standby mode a complete powering down of the receiver (210) is possible, or a partial powering down if it is desired to retain other functionality during the standby mode.

The selector controller (272) detects the standby command, and in response, switches the switching part (271) to couple (870) the output of the user activity detectors (410, 420) to the HPD line (330).

Both the source (100) and sink (200) are then in standby mode (880).

By directly switching the transmitter (110) to standby mode (880) and indirectly switching the receiver (210) to standby mode (880), the standby controller (160) disables bi-directional communication between the transmitter (110) and the receiver (210) via the auxiliary channel (321, 322).

During normal operation (810), the HPD line (330) is used by the transmitter (110) to detect IRQ interrupts and hot plugging events in the mode of operation defined in the DisplayPort standard. After performing the method (800) to switch to standby mode (880), the standby controller (160) is used to detect both a hot plugging event by the sink (200) and to detect wake-up requests from the sink (200).

The invention therefore provides a standby mode (880) in which the transmitter (110) and receiver (210) are powered down to reduce power consumption, but still allowing maximum flexibility to receive wake-up requests from either source (100) or sink (200), including from the IR detector (420) which detects remote control activity.

FIG. 7 depicts the method (700) for switching from the standby mode (710) according to the invention. Both the source (100) and the sink (200) are initially in standby mode (710), that is not in the operating mode. During this standby mode (710), the transmitter (110) and the receiver (210) are powered down.

The standby controller (160) detects (720) a wake-up request, which may come from the source (100) or the sink (200). In response to this request, the standby controller (160) generates (730) a wakeup command on the auxiliary line (321) to which it is connected. The standby controller (160) switches the transmitter (110) from standby mode and disables (750) the monitoring of the HPD line (330) for wake-up requests.

The display controller (220) the wakeup command, and in response, switches (760) the receiver (210) from standby mode.

The selector controller (272) detects the wake-up command, and in response, switches the switching part (271) to uncouple (770) the output of the user activity detectors (410, 420) from the HPD line (330).

Both the source (100) and sink (200) are then in the operating mode (780).

By directly switching the transmitter (110) from standby mode (710) and indirectly switching the receiver (210) from standby mode (710), the standby controller (160) enables bi-directional communication between the transmitter (110) and the receiver (210) via the auxiliary channel (321, 322).

In the standby mode (710), the HPD line (330) is used by the standby controller (160) to detect both a hot plugging event by the sink (200) and to detect wake-up requests from the sink (200). After performing the method (700) to switch from standby mode, the standby controller (160) no longer reacts to hot plugging events by the sink (200). In this operating mode (780), IRQ interrupts and hot plugging events are detected by the transmitter (110) in the mode of operation defined in the DisplayPort standard.

The source (100) and sink (200) may further comprise power supplies, configured to provide power to certain components and modules in standby mode. For example, the power supply may be a conventional 3V3 standby power supply. This allows even more control over the power consumption during the standby mode, as the components and modules may be configured to operate with a relatively low power. For example, the source (100) may comprise a source standby power supply (140) connected to the standby controller (160), and configured to provide power to the standby controller (160) in standby mode. The sink (200) may comprise a sink standby power supply (240) connected to display controller (220) and to the user activity detectors (410, 420), and configured to provide power to the controller (220) and detectors (420, 410) when the sink (200) is in standby mode.

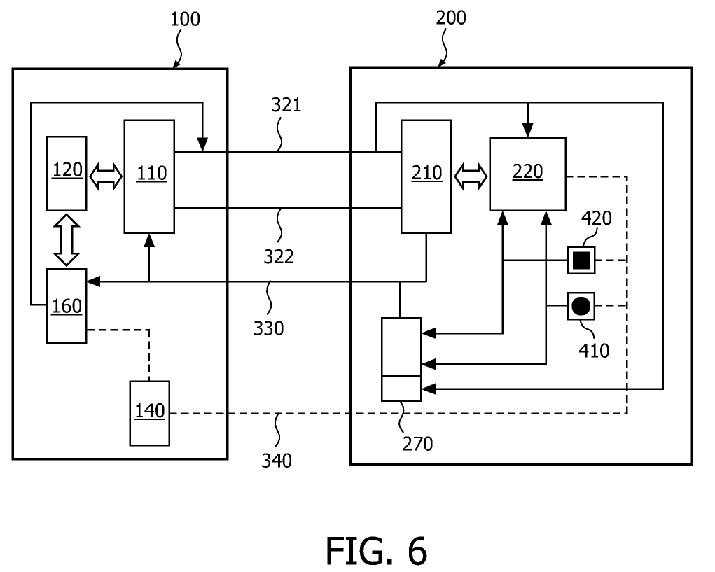

FIG. 6 depicts a third embodiment of the invention, which is the same as the second embodiment except that the sink (200) does not comprise a standby power supply (240). The source (100) and sink (200) are further configured to connect the source standby power supply (140) to the display controller (220) and to the user activity detectors (410, 420) in standby mode via a power line (340). The power line (340) is comprised in the interfacing between the source (100) and the sink (200), and this complies with the DisplayPort standard.

The advantage is that the source (100) is given even more control over the power dissipation at the sink (200) during the standby mode.

Alternatively, the third embodiment of the invention may be adapted such that the source (100) does not comprise a standby power supply (140). The source (100) and sink (200) are then further configured to connect the sink standby power supply (240) to the standby controller (160) in standby mode via the power line (340).

The general advantage to a common standby power supply is that the power consumption during standby mode becomes more predictable. This predictability is often important when configuring a system or devices to comply with power consumption requirements and regulations.

To maintain compatibility with the DisplayPort standard may be maintained by configuring the second channel (330) is to convey a low logical state in standby mode when no wake-up request is generated by the multimedia sink (200), and by configuring the multimedia sink (200) to generate the wake-up request in standby mode by asserting a high logical state via the second channel (330).

It may be advantageous to distinguish between the types of activity detected to generate the wake-up request—for example, that may be the activation of the on/off switch (410) or the detection by the IR detector (420) of remote control activity. This may be done by measuring the duration of the wake-up request is generated by the sink (200) via the HPD line (330)—typically the duration triggered by the activation of the on/off switch (420) will be considerably longer than the duration triggered by the IR detector (410).

It may be advantageous to configure the standby controller (160) in standby mode to distinguish between remote control codes received from the IR detector (420) so that a wake-up command is only generated when a specific wake-up request is detected, corresponding to a specific remote control code, or that the wake-up actions are different depending upon the remote control code received. However, the HPD line (330) may not be suitable for reliable transmission of remote control codes. This may be addressed by configuring the standby controller (160) to wake-up the transmitter (110) and receiver (210) upon detection of any remote control signal. The auxiliary channel (321, 322) may then be used to reliably transmit the remote control codes to the source (100).

It should be noted that the above-mentioned embodiments illustrate rather than limit the invention, and that those skilled in the art will be able to design many alternative embodiments without departing from the scope of the appended claims.

For example, the embodiments refer to a source comprising a main controller (120) and a standby controller (160), where the main controller (120) contains the main application and the standby controller (160) is only responsible for executing power down & power up sequences. It will be apparent to the skilled person that the actions performed within the context of the invention may be assigned to either controller (120, 160), and that it is also possible to use a single controller for all main controller (120) and standby controller (160) functions.

The embodiments also describe the sink (200) comprising a single display controller (220), but the sink (200) may also comprise a display controller and a sink standby controller, the sink standby controller being configured to perform the actions required by the sink (200) in performing the methods (700, 800) of the invention. A dedicated standby controller is advantageous for a source (100) or a sink (200) because it is only required to perform a limited selection of actions, meaning the complexity of the standby controller can be kept low. As low complexity may be implemented using fewer active elements, this may provide lower power consumption during the standby mode.

The methods of the invention may be encoded as program code within one or more programs, such that the methods are performed when these programs are run on one or more processors. The program code may also be stored on a computer readable medium, and comprised in a computer program product.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

In summary the invention relates to a method for switching a multimedia source and multimedia sink to a standby mode, and a method for switching a multimedia source and multimedia sink from standby mode When the consumer device comprises two distributed boxes, such as a TV in which the display (multimedia sink) is separated from the processing unit (multimedia source) via a cable, then meeting the green rules for standby power becomes more complicated. The power consumption of processing unit and display unit should be minimal in standby mode.

The methods of the invention provide for synchronizing the power states of both units, such that only the relevant parts remain active. The method is applicable on configurations where a DisplayPort link is used between a multimedia source, such as a set-top box, and a multimedia sink, such as a display.

The invention provides a reduction in overall power consumption, while still complying with the DisplayPort configuration and operation standard. In an embodiment of the invention, the source and sink are configured to allow communication of standby and wake-up requests/commands when the transmitter and receiver for the auxiliary channel are powered down.

The invention also provides embodiments where the switching to and from standby of the source is triggered by user interaction with the sink. This is convenient because the source is often hidden from view, and contributes to an improvement in power consumption reduction because the user no longer needs to monitor and control the mode of the source—the user can simply monitor and control the mode of the sink, which is mostly in view.

1. A method for switching a multimedia source (100) and multimedia sink (200) from an operating mode to a standby mode,
the multimedia source (100) having a transmitter (110) and a source standby controller (160) interfaced to the transmitter (110);
the multimedia sink (200) having a wake-up request generator, a receiver (210) and a sink standby controller (220) interfaced to the receiver (210) and the wake-up request generator;
the transmitter (110) and receiver (210) being interfaced via a first channel (320) for bi-directional communication in the operating mode;
the source standby controller (160) and the wake-up request generator being interfaced via a second channel (330) for detection of a wake-up request by the source standby controller (160) in the standby mode; the method comprising:
in response to detecting (820) a request to enter standby mode, the source standby controller (160):
generating (830) a standby command on the first channel (320);
disabling the source side of the bi-directional communication by switching (840) the transmitter (110) to the standby mode, and
enabling monitoring (850) for the wake-up request by the source standby controller (160) via the second channel (330);
in response to detecting the standby command, the sink standby controller (220):
disabling the sink side of the bi-directional communication by switching (860) the receiver (210) to the standby mode, and
enabling (870) the generation of the wake-up request by the wake-up request generator via the second channel (330).

2. The method of claim 1, wherein:
the transmitter (110) and receiver (210) are interfaced via the second channel (330) for hot plug detection of the sink (200) by the source (100) in the operating mode, and the method further comprises:
in response to detecting (820) a request to enter standby mode, the source standby controller (160) disabling the hot plug detection by switching (840) the transmitter (110) to the standby mode.

3. The method of claim 1, wherein the source standby controller (160) and sink standby controller (220) are directly interfaced via the first channel (320) for the communication of the standby command from the source (100) to the sink (200).

4. The method of claim 3, wherein:
the first channel comprises a first (321) and second (322) line, configured as an ac-coupled differential pair,
the source standby controller (160) is configured to generate (830) the standby command by varying the dc-level of the first line (321, 322), and
the sink standby controller (220) is configured to detect the variation in the dc-level of the first line (321, 322) as the standby command.

5. The method of claim 1, wherein the second channel (330) is configured to convey a low logical state in the standby mode when no wake-up request is generated by the wake-up request generator, and the wake-up request generator is configured to generate the wake-up request in the standby mode by asserting a high logical state via the second channel (330).

6. The method of claim 1, wherein:
the interfacing between the multimedia sink (200) and the multimedia source (100) further comprises a power line (340);
the multimedia source (100) further comprises a power supply (140) configured to supply power in the standby mode to the source standby controller (220) and to further supply power via the power line (340), and
the multimedia sink (200) is configured to supply power in the standby mode from the power line (340) to the wake-up request generator (220) and to the sink standby controller (220).

7. The method of claim 1, wherein the multimedia sink (200) comprises a power switch (420), and the multimedia sink (200) is configured to generate the request to enter standby mode when the power switch (420) is activated to off.

8. The methods of claim 1, wherein the wake-up request generator comprises a user activity detector (410, 420), and the enabling (870) of the generation of the wake-up request comprises coupling the output of the user activity detector (410, 420) to the second channel (330).

9. A method for switching a multimedia source (100) and multimedia sink (200) from a standby mode to an operating mode,
the multimedia source (100) having a transmitter (110) and a source standby controller (160) interfaced to the transmitter (110);
the multimedia sink (200) having a wake-up request generator, a receiver (210) and a sink standby controller (220) interfaced to the receiver (210) and the wake-up request generator;
the transmitter (110) and receiver (210) being interfaced via a first channel (320) for bi-directional communication in the operating mode;
the source standby controller (160) and the wake-up request generator being interfaced via a second channel (330) for detection of a wake-up request by the source standby controller (160) in the standby mode;
the method comprising:
in response to detecting (720) a wake-up request, the source standby controller (160):
enabling the source (100) side of the bi-directional communication by switching (740) the transmitter (110) to the operating mode, and
disabling (750) the detection of the wake-up request by the source standby controller (160) via the second channel (330);
in response to detecting the wake-up request, the sink standby controller (220):
enabling the sink (100) side of the bi-directional communication by switching (760) the receiver (210) to the operating mode, and
disabling (770) the generation of the wake-up request by the wake-up request generator.

10. The method of claim 9, wherein:
the transmitter (110) and receiver (210) are interfaced via the second channel (330) for hot plug detection of the sink (200) by the source (100) in the operating mode,
and the method further comprises:
in response to detecting (720) a wake-up request, the source standby controller (160) enabling the hot plug detection by switching (760) the receiver (210) to the operating mode.

11. The method of claim 9, wherein:
the source standby controller (160) and sink standby controller (220) are directly interfaced via the first channel (320) for the communication of a wake-up command from the source (100) to the sink (200);
the sink standby controller (220) acts in response to detecting the wake-up command instead of the wake-up request, and the method further comprises:
in response to detecting (720) the wake-up request, the source standby controller (160) generating (730) a wake-up command on the first channel (320)

12. The method of claim 11, wherein:
the first channel comprises a first (321) and second (322) line, configured as an ac-coupled differential pair,
the source standby controller (160) is configured to generate (730) the wake-up command by varying the dc-level of the first line (321, 322), and
the sink standby controller (220) is configured to detect the variation in the dc-level of the first line (321, 322) as the wake-up command.

13. The method of claim 9, wherein the multimedia sink (200) further comprises a power switch (420), and the wake-up request generator is configured to generate the wake-up request when the power switch (420) is activated to on.

14. The method of claim 8, wherein the wake-up request generator comprises a user activity detector (410, 420) and the disabling (770) of the generation of the wake-up request comprises uncoupling the output of the user activity detector (410, 420) to the second channel (330).

15. The method of claim 14, wherein user activity detector comprises a remote-control detector (410) and a power switch activation detector (420), and the method further comprises:
configuring the wake-up request generator to generate a first wake-up request when the multimedia sink (200) detects activation of a remote-control detector (410);
configuring the wake-up request generator to generate a second wake-up request when the multimedia sink (200) detects activation of a power switch (420), and
configuring the standby controller (160) to distinguish between the first and second wake-up requests.

16. A multimedia source (100) comprising:
a transmitter (110) and a source standby controller (160) interfaced to the transmitter (110);
the transmitter (110) having an interface to a first channel (320) for bi-directional communication with a multimedia sink (200) in the operating mode;
the source standby controller (160) having an interface to a second channel (330) for the detection of a wake-up request by the multimedia sink (200) in the standby mode;
the source standby controller (160) being configured:
to detect in the operating mode (820) a request to enter standby mode,
to generate (830) in the operating mode a standby command on the first channel (320);
to disable the source side of the bi-directional communication by switching (840) the transmitter (110) to the standby mode, and
to enable in standby mode monitoring (850) for the wake-up request via the second channel (330).

17. A multimedia sink (200) comprising:
the multimedia sink (200) having a wake-up request generator, a receiver (210) and a sink standby controller (220) interfaced to the receiver (210) and the wake-up request generator;
the receiver (210) having an interface to a first channel (320) for bi-directional communication with a multimedia source (100) in the operating mode;
the wake-up request generator having an interface to a second channel (330) for transmitting a wake-up request to the multimedia source (100) in the standby mode;
the sink standby controller (220) being configured:
to detect in the operating mode a standby command via the first channel;
to disable in the operating mode the sink side of the bi-directional communication by switching (860) the receiver (210) to the standby mode, and
to enable (870) in standby mode the generation of the wake-up request by the wake-up request generator via the second channel (330).
